(19) United States
(12) Patent Application Publication
(10) Pub. No.: US 2024/0359342 A1
(43) Pub. Date: Oct. 31, 2024

(54) ROBOTIC ARM AND GRIPPER VACUUM COLLECTION SYSTEM

(71) Applicant: Peter Mendre, Haverhill, MA (US)

(72) Inventor: Peter Mendre, Haverhill, MA (US)

(21) Appl. No.: 18/649,720

(22) Filed: Apr. 29, 2024

Related U.S. Application Data
(60) Provisional application No. 63/499,135, filed on Apr. 28, 2023.

(51) Int. Cl. B25J 15/06; B25J 15/00

(52) U.S. Cl. CPC B25J 15/0683; B25J 15/0052

(57) ABSTRACT

A vacuum system with multiple suction cups is provided to grasp and move irregularly-shaped objects to reduce the likelihood of dropping the object and contaminating collections of objects, for instance, when sorting objects in a recycling facility. In some embodiments, each suction cup is part of a spindle that moves independently with respect to a spindle flange assembly, and each suction cup is made of a pliable and deformable material. Therefore, as the vacuum system presses the suction cups into an object, the suction cups can deform and/or the spindle can move to better conform the suction cups to the irregularly-shaped object. A pump or other device can draw air through a lower opening in each suction cup to form a seal with the object. As a result, smaller cups and less powerful pumps can be used for improved sorting of objects and material.

### CROSS-REFERENCE TO RELATED APPLICATIONS

This application claims priority to U.S. Provisional Patent Application Ser. No. 63/499,135 filed Apr. 28, 2023, which is incorporated herein in its entirety by reference.

### FIELD OF THE INVENTION

The disclosure relates to a vacuum system for moving objects, in particular solid recyclable objects, that may have a variety of sizes, shapes, colors, and/or other characteristics.

### BACKGROUND OF THE INVENTION

Recycling has many positive benefits including reducing the amount of waste sent to landfills, conserving natural resources, and eliminating pollution that would otherwise be incurred during the collection of new raw resources. Various programs and efforts consistently increase the amount of solid recyclable objects delivered to recycling facilities, and once at the recycling facilities, the objects can be sorted for further processing. The objects can be sorted by any number of characteristics such as size, shape, and/or color. Moreover, the objects can be sorted according to the material of the object such as metal, glass, plastic, etc. Sorting allows like material to be processed with like material because different materials can have different recycling processes. For instance, plastic has different types that may require different recycling processes, including high density polyethylene (HDPE), low density polyethylene (LDPE), linear low density polyethylene (LLDPE), polypropylene (PP), polyethylene terephthalate (PET), polyvinyl chloride (PVC), polystyrene (PS).

Regardless of the characteristic, or characteristics, by which the objects are sorted, the sorting process requires separating an object from other objects. In one example, objects travel along a conveyor belt, and air blows lighter paper objects away from denser objects made from metal, glass, or plastic. In another example, one or more magnets are used to separate ferrous metal objects from non-ferrous metal objects. These processes are useful but separate objects from other objects based on only one characteristic at a time. In a further example, an object is characterized and then individually moved to another location to quickly and precisely sort the objects in a recycling facility. Some recycling facilities use a vacuum system with a vacuum head to grasp and move a single object to another location. However, prior art vacuum systems have several drawbacks.

A given object may begin with a simple shape but can become distorted with many variable and uneven surfaces, and a vacuum head may become ineffective at grasping an object with a vacuum seal. To compensate, the system may direct the vacuum head to a flat surface of the object, but an object often does not have a flat surface that is sufficiently large to create a vacuum seal with a vacuum head. Moreover, targeting a flat surface often places the vacuum head off center, which increases the likelihood that the object will not balance and will be lost before reaching another location. Further still, targeting a flat surface requires varying the vacuum head from the center of the object, which increases the likelihood that an undesired object is mixed with desired objects and contaminates a sorted collection of desired objects.

Some systems simply increase the size of the vacuum head and strength of the vacuum, but this increases the likelihood that the vacuum head itself draws in contaminants. In addition, the larger vacuum system requires more power, which may stand in opposition to the environmental nature of a recycling facility.

### SUMMARY OF THE INVENTION

Embodiments of the present disclosure relate to a novel vacuum system with multiple suction cups that consistently grasps irregularly-shaped objects with a vacuum seal. In some embodiments, the suction cups each have a corrugated portion and each suction cup is positioned at the end of a movable spindle to better conform to the shape of an object. As a result, the vacuum system is less likely to drop an object and less likely to contaminate a sorted group of objects. Moreover, the vacuum system requires less power, which aids in the environmental effort of the recycling facility.

It is one aspect of embodiments of the present disclosure to provide a vacuum system that has suction cups that each have a corrugated portion to better conform to various shapes of different objects. The suction cup is made of a pliable material that is more deformable than the part of the spindle to which the suction cup is joined. In various embodiments, the suction cup is made of one of a rubber material, an elastomeric material, a plastic material, or other similarly deformable material capable of creating an adequate seal on the object being grabbed. In some embodiments, the suction cup has a corrugated portion comprising at least one ridge and at least one groove. Alternatively, the suction cup may not have a corrugated portion but rather compresses on the item of interest via a spring loaded slide, a gimbal component, or other compression mechanism. In additional embodiments, the vacuum system comprises one or more suction cups, each having a corrugated portion, a spring loaded slide, and/or a gimbal component.

Typically, the suction cup has a generally cylindrical shape, which could be oval or square shaped in various embodiments, with a lower opening configured to draw in air and with an upper opening operably engaged with part of the spindle, typically a fitting. In the corrugated embodiments, the ridge of the corrugated portion is a larger diameter part of the suction cup, and the groove is a smaller diameter part of the cup. With the pliable material and the corrugated portion, the suction cup can compress along an axis and even gimbal off axis to better conform to an irregularly-shaped object and form a vacuum seal with the object. Each suction cup can gimbal off axis independently such that one suction cup can rotate or tilt in one direction while another suction cup rotates or tilts in another direction to grab different portions of a distorted target object, e.g., a crushed water bottle. In embodiments without the corrugated portion, the suction cup also compresses along an axis and can gimbal off axis to compress and conform to the desired object. When the vacuum system disengages the object, the suction cup returns to its uncompressed and undeformed shape.

It is one aspect of the embodiments to provide a vacuum system with a slide feature, which may use a spring, to permit the suction cup to move up and down. However, the present disclosure includes embodiments without the slide feature and, rather, the vacuum system uses another mechanism to change the height of the suction cup. For example, accordion ridges could be used instead of the slide functionality described herein.

It is another aspect of embodiments of the present disclosure to provide a vacuum system with a movable spindle. The vacuum system comprises a central conduit through which a pump or other device draws air. A spindle flange assembly is attached to a lower end of the central conduit and the spindle is movably connected to the spindle flange assembly. The spindle has a spindle conduit with an interior volume that is fluidly connected to the central conduit, and a fitting joins a suction cup to a lower end of the spindle conduit. Thus, when a pump or other device draws air through the vacuum system, air is drawn through the lower opening of the suction cup, through the interior space of the spindle conduit, through the central conduit, and to the pump or other device.

When the vacuum system engages an object, the spindle can move along an axis and relative to the spindle flange assembly and the central conduit. When the vacuum system disengages the object, the spindle can revert to its original, extended position. A bias member can be positioned between part of the spindle and part of the spindle flange assembly to revert the spindle to its original, extended position. The bias member can be, for instance, a spring with a linear response or a non-linear response. In other embodiments, the bias member is another deflectable material, a pneumatic system, an airbag, gravity system, etc.

In some embodiments, the vacuum system comprises two or more small (1 inch in diameter or smaller) suction cups, each with a corrugated portion, but the suction cups optionally slide up and down individually. However, the suction cups may each be attached to a gimbal component such that the suction cups can move in all directions.

In other embodiments, the vacuum system is designed for trash and recycling sorting and has only one suction cup with a diameter of 1 inch or less and the suction cup has a spindle and a gimbal component permitting the suction cup to rotate or move in all directions, i.e., all directions of freedom.

It is a further aspect of embodiments of the present disclosure to provide a vacuum system with different numbers and arrangements of independently movable spindles and respective suction cups. For instance, the vacuum system can have one, two, three, four, five, etc. spindles with respective suction cups. In some embodiments, the vacuum system has two movable spindles with respective suction cups where one spindle is coaxial with the central conduit through which air is drawn, and another spindle is oriented along an axis that is offset from the central conduit. In an arrangement of four spindles and respective suction cups, one spindle is coaxial with the central conduit and the other three spindles are offset from and evenly arrayed about the central conduit. In other embodiments, the three spindles offset from the central conduit are not evenly arrayed about the central conduit. For example, one may be 1 inch away from the central conduit, one may be 2 inches aways form the central conduit, and one may be 3 inches away from the central conduit, but all are arranged 120 degrees apart about a longitudinal axis of the central conduit. Alternatively, each spindle is the same distance from the central conduit, but the three spindles are not evenly spaced around the central conduit, meaning they are not 120 degrees apart. In still further embodiments, the three spindles may each be different distances from the central conduit and they may not be evenly spaced around the central conduit such that they are more or less than 120 degrees apart from one another. In an arrangement of three spindles and respective suction cups, one spindle is coaxial with the central conduit and the other two spindles are offset from and evenly arrayed about the central conduit. In other embodiments, the two spindles offset from the central conduit are not evenly arrayed about the central conduit.

In various embodiments, the vacuum system does not have a central spindle and suction cup that is coaxial with the central conduit. Further still, a spindle and respective suction cup may be oriented along an axis that is not parallel with the axis of the central conduit. In some embodiments, the spindles and respective suction cups are the same size with the same flow rate of air drawn through each spindle and respective suction cup. In other embodiments, the spindles and/or suction cups have different sizes, and/or air is drawn at different flow rates. These different aspects of the vacuum system can be changed to best conform to a particular type of object.

For example, four spindles and suction cups positioned around a central suction cup is helpful when moving heavier items such as detergent bottles. In other instances with smaller items, fewer spindles and suction cups are preferred to avoid collected unwanted items. For an amazon box, a three spindle configuration is preferable, and for a single use water bottle, a two spindle configuration is preferable.

In addition, the spindles are independently movable relative to the spindle flange assembly, meaning the suction cups on the end of each spindle can be positioned at different heights to attach to different portions of a distorted target object. As the vacuum system presses into an irregularly-shaped object, a suction cup at the end of a spindle is free to reach to a surface of the object between two high points. Another suction cup on another spindle may contact a high point to cause the spindle to move relative to the spindle flange assembly. Yet, both suctions cups on both spindles contact the object to grasp and move the object. Thus, the vacuum system described herein can grasp objects with an irregular shape, a curved shape, a flat shape, etc.

Another advantage of embodiments of the present invention is that each suction cup can move in a circular motion, tip to the right, left, front, or back between about 1 degree and 15 degrees, and move up and down. Therefore, the suction cup can move in all directions, i.e., in all degrees of freedom. This movement permits the suction cup to find a relatively flat spot to which it can suction/attach to the item of interest.

It is another aspect of embodiments of the present disclosure to provide a vacuum system that can be quickly changed between different configurations of spindles and respective suction cups. The spindles can be movably engaged with a spindle flange assembly, which in turn can be readily fastened to a lower end of the central conduit with one or more fasteners. This allows different spindle flange assemblies with different numbers of spindles, configurations of spindles, etc. to be swapped out with only a few fasteners. Moreover, one or more channels can extend into an outer surface of the central conduit, and these channels can be used to quickly engage the channel with a robotic arm, a hose leading to a pump or other device, etc. In some embodiments, the entire head portion can be changed, meaning a head with four 1-inch suction cups could be removed and a head with three 1.5-inch suction cups could be attached to the vacuum and/or central conduit. Alternatively, the suction cups can be removed and switched out for different sized suction cups. Further, one or more spindle and suction cup can be removed and the hose for that spindle and suction cup closed off with a cap or by turning a valve.

A further aspect of embodiments of the present disclosure is to provide a vacuum system that can detect when an object is secured among other functions. In some embodiments, magnets are positioned on, for example, the spindle. Then, magnets sensors can detect movement of the spindle relative to the central conduit. One sensor can detect movement of the spindle by a first distance that corresponds to “Part Detected”, which signals the system to stop compressing on the part and initiates the part place routine. Another sensor can detect movement of the spindle by a second distance that corresponds to “Part Interference” which signals the system that a part is being compressed, and the end of the allowable compression distance has been exceeded. Subsequently, the motion of the system is cancelled, and a system fault or a robot fault is triggered.

A first aspect of the present disclosure is to provide a vacuum system, comprising a central conduit having an interior space extending between an upper opening and a lower opening; a spindle flange assembly joined to a lower end of the central conduit; a first spindle movably engaged with the spindle flange assembly, wherein the first spindle comprises a first suction cup fluidly connected to the interior space of the central conduit, the first suction cup having an opening through which air is configured to be drawn to selectively form a seal with an object; and a first bias member configured to bias the first suction cup away from the spindle flange assembly; and a second spindle movably engaged with the spindle flange assembly, wherein the second spindle comprises a second suction cup fluidly connected to the interior space of the central conduit, the second suction cup having an opening through which air is configured to be drawn to selectively form a seal with the object; and a second bias member configured to bias the second suction cup away from the spindle flange assembly.

The vacuum system of the first aspect may include, optionally, that the first suction cup has a corrugated portion, and the first suction cup is oriented along an axis, wherein the first suction cup is configured to compress along the axis by up to a predetermined distance, and the first suction cup is configured to gimbal off of the axis.

The vacuum system of the first aspect may include one or more of the previous embodiments and, optionally, that the first suction cup is joined to a first suction cup fitting of the first spindle, the first suction cup is made of a material that is more pliable than a material of the first suction cup fitting, and the corrugated portion of the first suction cup comprises a ridge and a groove, wherein a diameter of the ridge is greater than a diameter of the groove.

The vacuum system of the first aspect may include one or more of the previous embodiments and, optionally, that the first suction cup fitting is joined to a first spindle conduit, and the first bias member is disposed about the first spindle conduit such that a lower end of the first bias member is configured to contact the first suction cup fitting, and an upper end of the first bias member is configured to contact the spindle flange assembly.

The vacuum system of the first aspect may include one or more of the previous embodiments and, optionally, that the spindle flange assembly comprises a first bushing and a second bushing joined to a spindle flange, wherein each of the first bushing and the second bushing extend farther in a thickness direction than the spindle flange, wherein the first spindle is configured to extend through the first bushing, and the second spindle is configured to extend through the second bushing.

The vacuum system of the first aspect may include one or more of the previous embodiments and, optionally, that the first spindle comprises a nut and a seal joined to an upper end of the first spindle conduit to secure the first spindle to the spindle flange assembly, and the first spindle is coaxial with the central conduit; and wherein the second spindle comprises a spindle fitting joined to an upper end of a second spindle conduit to secure the second spindle to the spindle flange assembly, wherein a hose is joined to the spindle fitting, and a central conduit fitting is joined to both the hose and a port of the central conduit to fluidly connect the second suction cup to the interior space of the central conduit, and wherein the second spindle extends along an axis that is offset from an axis of the central conduit.

The vacuum system of the first aspect may include one or more of the previous embodiments and, optionally, that the first suction cup and the second suction cup are separated by an offset, and wherein the offset is between one to two times larger than one of a first outer diameter of the first suction cup or a second outer diameter of the second suction cup.

A second aspect of the present disclosure is to provide a vacuum system, comprising a central conduit having an interior space extending between an upper opening and a lower opening; a spindle flange assembly joined to a lower end of the central conduit; a first spindle movably engaged with the spindle flange assembly, the first spindle having a first suction cup fluidly connected to the interior space of the central conduit, the first suction cup having an opening through which air is configured to be drawn to selectively form a seal with an object, and the first suction cup having a first outer diameter; a second spindle movably engaged with the spindle flange assembly, the second spindle having a second suction cup fluidly connected to the interior space of the central conduit, the second suction cup having an opening through which air is configured to be drawn to selectively form a seal with the object, and the second suction cup having a second outer diameter; and wherein the first suction cup and the second suction cup are separated by an offset, and wherein the offset is between one to two times larger than one of the first outer diameter or the second outer diameter.

The vacuum system of the second aspect may include, optionally, that the first suction cup is configured to compress along a first axis by up to a predetermined distance, and the first suction cup is configured to gimbal off of the first axis.

The vacuum system of the second aspect may include one or more of the previous embodiments and, optionally, that the first suction cup has a first corrugated portion with a ridge and a groove, and the second suction cup has a second corrugated portion with a ridge and a groove, wherein the offset is between the ridge of the first corrugated portion and the ridge of the second corrugated portion.

The vacuum system of the second aspect may include one or more of the previous embodiments and, optionally, that a first suction cup fitting is joined to the first suction cup and to a first spindle conduit, and a first bias member is disposed about the first spindle conduit such that a lower end of the first bias member is configured to contact the first suction cup fitting, and an upper end of the first bias member is configured to contact the spindle flange assembly.

The vacuum system of the second aspect may include one or more of the previous embodiments and, optionally, that the first spindle comprises a nut and a seal joined to an upper end of the first spindle conduit to secure the first spindle to the spindle flange assembly, and the first spindle is coaxial with the central conduit.

The vacuum system of the second aspect may include one or more of the previous embodiments and, optionally, that the second spindle comprises a spindle fitting joined to an upper end of a second spindle conduit to secure the second spindle to the spindle flange assembly, wherein a hose is joined to the spindle fitting, and a central conduit fitting is joined to both the hose and a port of the central conduit to fluidly connect the second suction cup to the interior space of the central conduit.

The vacuum system of the second aspect may include one or more of the previous embodiments and, optionally, a third spindle with a third suction cup having a third offset from the first suction cup, a fourth spindle with a fourth suction cup having a fourth offset from the first suction cup, and a fifth spindle with a fifth suction cup having a fifth offset from the first suction cup, wherein the third, fourth, and fifth offsets are equal to the offset between the first and second suction cups.

A third aspect of the present disclosure is to provide a vacuum system, comprising a central conduit having an interior space extending between an upper opening and a lower opening; a spindle flange assembly joined to a lower end of the central conduit; a first spindle movably engaged with the spindle flange assembly, wherein the first spindle comprises a first suction cup fluidly connected to the interior space of the central conduit, the first suction cup having an opening through which air is configured to be drawn to selectively form a seal with an object; and a first bias member configured to bias the first suction cup away from the spindle flange assembly; and a fluid connection assembly having a first elbow, a second elbow, and a tubing rotatably connected to each of the first elbow and the second elbow, wherein the fluid connection assembly is configured to accommodate movement of the first spindle relative to the spindle flange assembly.

The vacuum system of the third aspect may include, optionally, that the fluid connection assembly further comprises a central conduit fitting joined to the central conduit; a second tubing rotatably connected to each of the central conduit fitting and the first elbow; a spindle fitting joined to the spindle flange assembly; and a third tubing rotatably connected to each of the spindle fitting and the second elbow.

The vacuum system of the third aspect may include one or more of the previous embodiments and, optionally, that the tubing is rigid and has a Young's Modulus of more than 0.1 GPa.

The vacuum system of the third aspect may include one or more of the previous embodiments and, optionally, a second suction cup fluidly connected to the interior space of the central conduit, the second suction cup having an opening through which air is configured to be drawn to selectively form a seal with the object; and a second bias member configured to bias the second suction cup away from the spindle flange assembly.

The vacuum system of the third aspect may include one or more of the previous embodiments and, optionally, that the first suction cup and the second suction cup are separated by an offset, and wherein the offset is between one to two times larger than one of a first outer diameter of the first suction cup or a second outer diameter of the second suction cup.

The vacuum system of the third aspect may include one or more of the previous embodiments and, optionally, that the first suction cup has a corrugated portion, and the first suction cup is oriented along an axis, wherein the first suction cup is configured to compress along the axis by up to a predetermined distance, and the first suction cup is configured to gimbal off of the axis.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present disclosure. Moreover, references made herein to “the present invention”, or aspects thereof should be understood to mean certain embodiments of the present invention/disclosure and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

It is to be appreciated that any feature or aspect described herein can be claimed in combination with any other feature(s) or aspect(s) as described herein, regardless of whether the features or aspects come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein. Additional figures of the present disclosure can be found in an Appendix, which is incorporated herein in its entirety by reference.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments and together with the general description of the invention given above and the detailed description of the drawings given below, serve to explain the principles of the invention.

FIG. 1A is a perspective view of a vacuum system in accordance with an embodiment of the present disclosure;

FIG. 1B is another perspective view of the vacuum system in FIG. 1A in accordance with an embodiment of the present disclosure;

FIG. 1C is a further perspective view of the vacuum system in FIG. 1A in accordance with an embodiment of the present disclosure;

FIG. 2A is a perspective view of a central conduit of the vacuum system in FIG. 1A in accordance with an embodiment of the present disclosure;

FIG. 2B is another perspective view of the central conduit in FIG. 2A in accordance with an embodiment of the present disclosure;

FIG. 3A is a perspective view of a spindle flange assembly of the vacuum system in FIG. 1A in accordance with an embodiment of the present disclosure;

FIG. 3B is another perspective view of the spindle flange assembly in FIG. 3A in accordance with an embodiment of the present disclosure;

FIG. 4A is a perspective view of spindles of the vacuum system in FIG. 1A in accordance with an embodiment of the present disclosure;

FIG. 4B is another perspective view of the spindles in FIG. 4A in accordance with an embodiment of the present disclosure;

FIG. 5 is a perspective, exploded view of a spindle in accordance with an embodiment of the present disclosure;

FIG. 6A is a perspective view of another vacuum system in accordance with an embodiment of the present disclosure;

FIG. 6B is another perspective view of the vacuum system in FIG. 6A in accordance with an embodiment of the present disclosure;

FIG. 7A is a perspective view of a further vacuum system in accordance with an embodiment of the present disclosure;

FIG. 7B is another perspective view of the vacuum system in FIG. 7A in accordance with an embodiment of the present disclosure;

FIG. 8A is a perspective view of a further vacuum system in accordance with an embodiment of the present disclosure;

FIG. 8B is a side elevation view of the vacuum system in FIG. 8A in accordance with an embodiment of the present disclosure; and

FIG. 8C is a bottom plan view of the vacuum system in FIG. 8A in accordance with an embodiment of the present disclosure.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.
2 Vacuum System
4 Central Conduit
6 Axis (Central Conduit)
8 Upper Opening (Central Conduit)
10 Spindle Flange Assembly
12a, 12b Spindle
12c, 12d Spindle
14 Axis (Second Spindle)
16a, 16b Suction Cup
17 Width (Suction Cup)
18a, 18b Lower Opening (Suction Cup)
19 Offset (Suction Cups)
20 Height (Suction Cup)
22 Compression Direction (Suction Cup)
24 Gimbal Direction (Suction Cup)
26 Compression Distance (Spindle)
28 Compression Direction (Spindle)
30 First Channel
32 Second Channel
34 First Port
36 Second Port
38 Fitting
40 Third Port
42 Lower Opening (Central Conduit)
44 Connection Recess
46 Spindle Flange
48 First Spindle Bushing
50 Bushing Fastener
52 Second Spindle Bushing
54 Connection Aperture
56 Nut
58 O-Ring
60 Central Conduit Fitting
62 Hose
64 Spindle Fitting
66 Spindle Conduit
68 Upper Thread
70 Lower Thread
72 Bias Member
74 Upper End
76 Lower End
78 Suction Cup Fitting
80 Corrugated Portion
82 Ridge
84 Groove
86 Quick-Connect Device
88a, 88b, 88c Tubing
90 First Elbow
92 Second Elbow
94 Bias Member
96 Plate
98 Seal
100 Clip
102 Quick-Connect Device
104 Axis (Tubing)
106 Rotation Direction (Tubing)

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the transmission would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the transmission can be combined with dimensions, aspects, and features of another embodiment of the transmission to create the claimed embodiment.

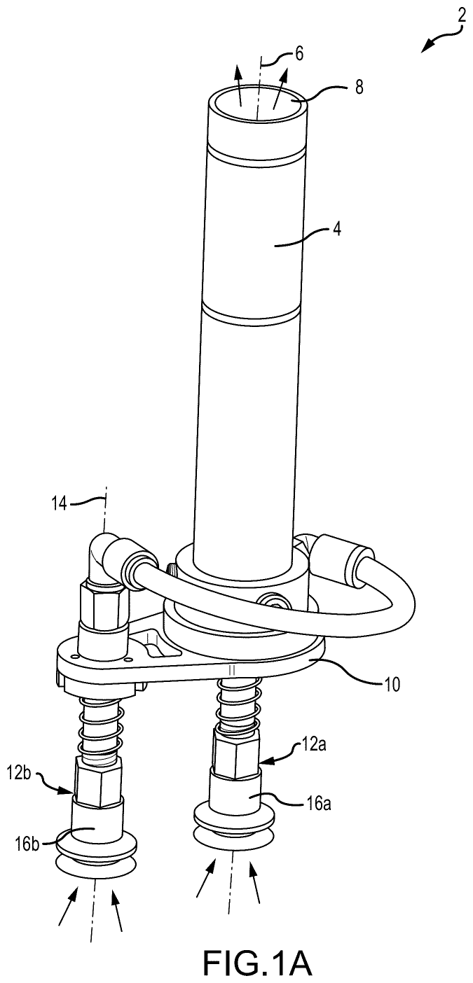

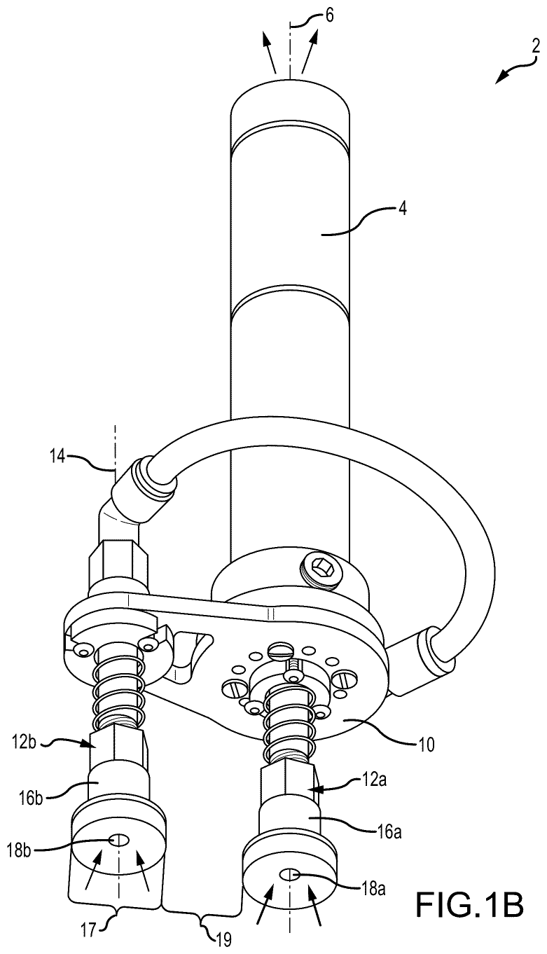

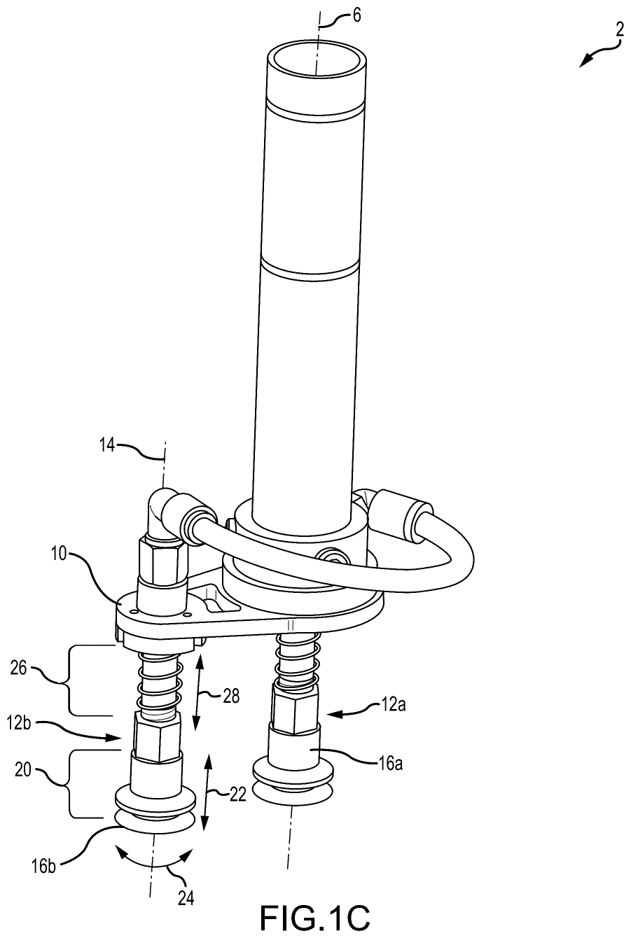

FIGS. 1A-1C show perspective views of a vacuum system 2 that can grasp and hold irregularly-shaped objects with a vacuum seal. The vacuum system 2 has a central conduit 4 oriented along an axis 6 in this embodiment, and the central conduit 4 can be fluidly connected to a pump or other device through an upper opening 8 of the central conduit 4. The pump or other device moves air through the vacuum system 2 as shown by arrows at the bottom of suction cups 16a, 16b and at the top of the central conduit 4 in FIGS. 1A and 1B. A spindle flange assembly 10 is joined to a lower end of the central conduit 4, and as described in further detail herein, various spindle flange assemblies 10 with different configurations of spindles 12a, 12b and suction cups 16a, 16b can be quickly joined and removed from the central conduit 4 to grasp and hold different objects.

The vacuum system 2 has two spindles 12a, 12b that selectively and independently move relative to the spindle flange assembly 10 to conform to the shape of an object such that the suction cups at the end of each spindle 12a, 12b can be positioned at different heights relative to one another and the material on the belt being sorted by the vacuum system. One spindle 12a is coaxial with the axis 6 of the central conduit 4, and the other spindle 12b is oriented along an axis 14 that is parallel to and offset from the axis 6 of the central conduit 4. A suction cup 16a, 16b is positioned at the lower end of each spindle 12a, 12b, and air is drawn in through a lower opening 18a, 18b on each suction cup 16a, 16b.

The relative sizing and spacing of the suction cups 16a, 16b can be critical for the overall system to achieve the more efficient and effective moving of items, as described herein. As shown in FIG. 1B, a suction cup 16b has an outer diameter 17 as defined by a lowermost ridge in this embodiment. The outer diameter 17 is between approximately 0.5 inch and 3 inches in some embodiments. In various embodiments, the outer diameter 17 is less than approximately 2 inches. In some embodiments, the outer diameter 17 has a maximum outer diameter of approximately 1 inch. This relatively smaller diameter 17 and smaller suction cup 16b means less suction is needed through a lower opening 18b and a less powerful vacuum pump is needed, making the system more efficient.

Also depicted in FIG. 1B is an offset 19 between the suction cups 16a, 16b, which supports the efficiency and effectiveness of the overall system. A tighter spacing among suction cups 16a, 16b helps prevent the collection of unwanted items but too small of spacing among suction cups 16a, 16b could interfere with the functionality of one or both of the suction cups 16a, 16b. Thus, in some embodiments, the offset 19 is between approximately one and two times the outer diameter 17 of a suction cup 16b. In absolute terms, the offset 19 can be between approximately 2 and 4 inches. In other embodiments, the offset 19 can be between approximately 1 to 3 inches. With this arrangement of sizing and spacing of multiple suction cups 16a, 16b, the system is more efficient and also more effective in moving irregular shaped items.

FIG. 1C shows a perspective view of the vacuum system 2 where the various movements of the spindles 12a, 12b and respective suctions cups 16a, 16b are shown that allow the vacuum system 2 to better conform to an irregularly-shaped object. With respect to the second spindle 12b, the suction cup 16b is made of a pliable material that is compressible and deformable. Specifically, the suction cup 16b has a height 20, and when the vacuum system 2 is pressed into an object, the suction cup 16 can compress in a direction 22 along the axis 14 such that the height 20 is reduced by up to approximately 6 inches in some embodiments. In various embodiments, the height 20 can be reduced by up to approximately 3 inches. In other embodiments included herein including FIG. 1C, the height 20 can be reduced by approximately 1-2 inches. Moreover, with the suction cup 16b made of a pliable material, the suction cup 16b can gimbal in a direction 24 off of the axis 14 to conform to the shape of the object.

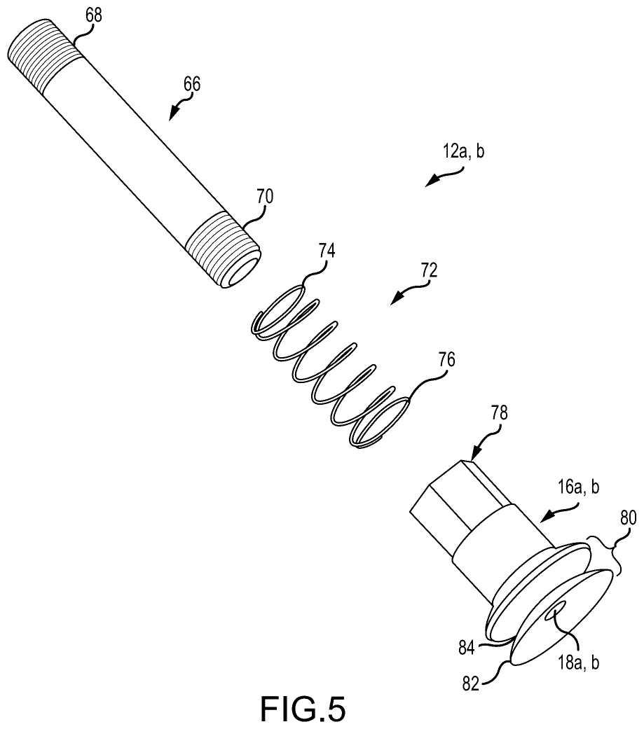

Next, the spindle 12b is movable relative to the spindle flange assembly 10. In particular, the spindle 12b can move in a direction 28 along the axis 14 as the vacuum system 2 is pressed into an object. As described in further detail herein, a bias member (72 in FIG. 5) can compress by a distance 26 to allow the spindle 12b to move relative to the spindle flange assembly 10. This distance 26 can be up to approximately 5 inches in some embodiments. In various embodiments, the distance 26 is up to approximately 8 inches. In various embodiments, the distance 26 is between approximately 2 and 10 inches. Once the vacuum system 2 is disengaged, the bias member drives the spindle 12b back to an extended position as shown in FIG. 1C. Similarly, once the vacuum system 2 is disengaged, the elastic nature of the suction cup 16b returns the suction cup 16 to its original shape and position.

Each spindle 12a, 12b is independently movable and each respective suction cup 16a, 16b is individually deformable, which allows the vacuum system 2 to better conform to an irregularly-shaped object, such as a crushed plastic water bottle or crushed milk jug. As a result, the vacuum system is less likely to drop an object and less likely to contaminate a sorted group of objects with undesired objects. This arrangement with multiple, movable spindles 12a, 12b and movable suction cups 16a, 16b allows the suction cups 16a, 16b to be smaller and the vacuum system 2 to use less power, which aids in the environmental effort of the recycling facility.

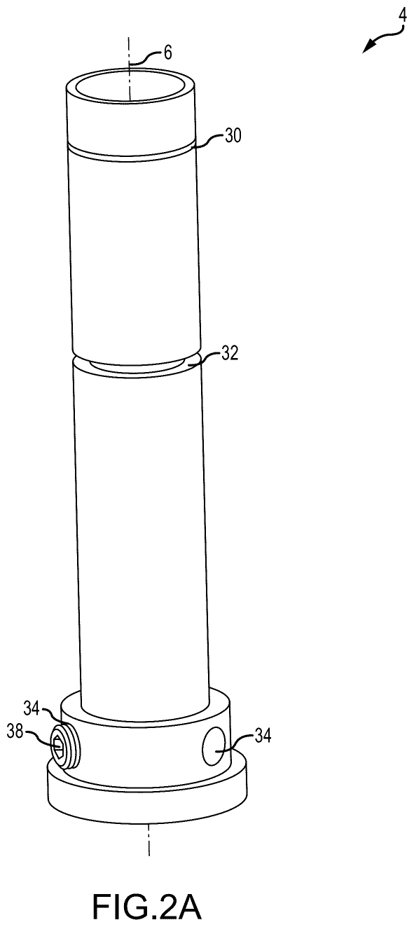

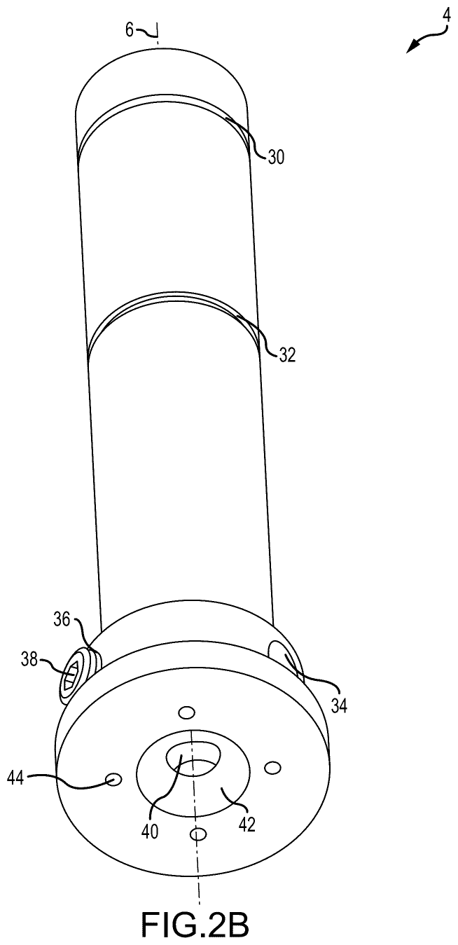

FIGS. 2A and 2B show perspective views of a central conduit 4 of the vacuum system. The central conduit 4 has a lower opening 42, an upper opening 8, and an interior space extending therebetween. Three ports 34, 36, 40 extend through a side of the central conduit 4 to provide access to the interior space. Each port 34, 36, 40 can optionally correspond to a movable spindle and respective suction cup. In a particular configuration of spindles that does not utilize every port 34, 36, 40, a fitting 38 can extend into a non-utilized port 34, 36, 40 to seal and close the overall vacuum system. With reference to FIGS. 1A-1C, one spindle (12a) interfaces with the lower opening 42 of the central conduit 4, and another spindle (12b) interfaces with one of the ports 34. During operation, air is drawn in through the suction cups and spindles, through the lower opening 42 and port 34, and through the central conduit 4 to a pump or other device to provide the vacuum function.

The central conduit 4 may optionally comprise one or more channels 30, 32 extending into the side of the central conduit 4 to provide a location to join, for example, a hose that leads to a pump or other device, a robotic arm that manipulates the vacuum system, etc. In addition, four connection recesses 44 extend into a lower surface of the central conduit 4 and provide a location for a spindle flange assembly (10 in FIGS. 1A-1C) to connect. Different spindle flange assemblies can have different arrangements of spindles, and therefore, can be quickly removed and fastened to the connection recesses 44. Then, spindles can be operably joined to ports 34, 36, 40 or fittings can be inserted into the ports 34, 36, 40, as needed. While the depicted embodiment shows three ports 34, 36, 40 evenly arrayed about the axis 6 of the central conduit 4, it will be appreciated that embodiments of the present disclosure include any number of ports 34, 36, 40 in any configuration.

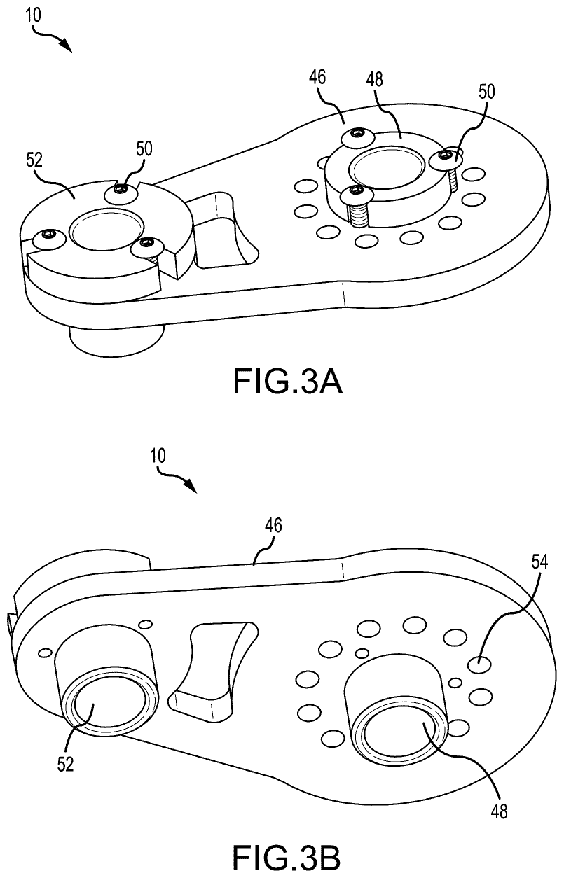

In addition, it will be appreciated that the central conduit 4 can have any number of shapes, including shapes beyond the generally cylindrical shape oriented along an axis 6, as shown in FIGS. 2A and 2B. In some embodiments, the central conduit 4 may have a curved shape. Thus, the orientations of various components may be described with respect to, for example, the plane in which the spindle flange (46 in FIGS. 3A and 3B) is oriented. For instance, the spindles 12a, 12b are oriented along axes that can be described as perpendicular to the plane of the spindle flange.

FIGS. 3A and 3B show perspective views of a spindle flange assembly 10, which is joined to the central conduit and to which spindles are movably connected. The spindle flange 46 itself extends in a generally planar direction, which when joined to the central conduit is oriented perpendicular to the axis of the central conduit (see axis 6 in FIGS. 2A and 2B) in this embodiment. A first bushing 48 and a second bushing 52 are joined to the spindle flange 46 with fasteners 50. The bushings 48, 52 correspond to the first and second spindles (12a, 12b in FIGS. 1A-1C), respectively. A spindle conduit (66 in FIG. 5) for each spindle extends through each bushing 48, 52 respectively. The spindle conduit moves within the bushing 48, 52 as the spindle moves relative to the spindle flange assembly. The bushings 48, 52 extend farther than the thickness direction of the spindle flange 46 (i.e., along the axes 6, 14 in FIGS. 1A-1C) to prevent tilting of the spindle conduits (66 in FIG. 5) and to limit movement of the spindles along the respective axes (6, 14, in FIGS. 1A-1C). In various embodiments, the bushings 48, 52 and the spindle flange 46 are a single, continuous structure. Connection apertures 54 through the spindle flange 46 allow fasteners to extend through the apertures 54 into the connection recesses (44 in FIG. 2B) of the central conduit to join the spindle flange assembly 10 to the central conduit (4 in FIGS. 1A-2B). The spindle flange 46 can be joined to the central conduit in multiple, optional orientations about the axis of the central conduit (see axis 6 in FIGS. 2A and 2B).

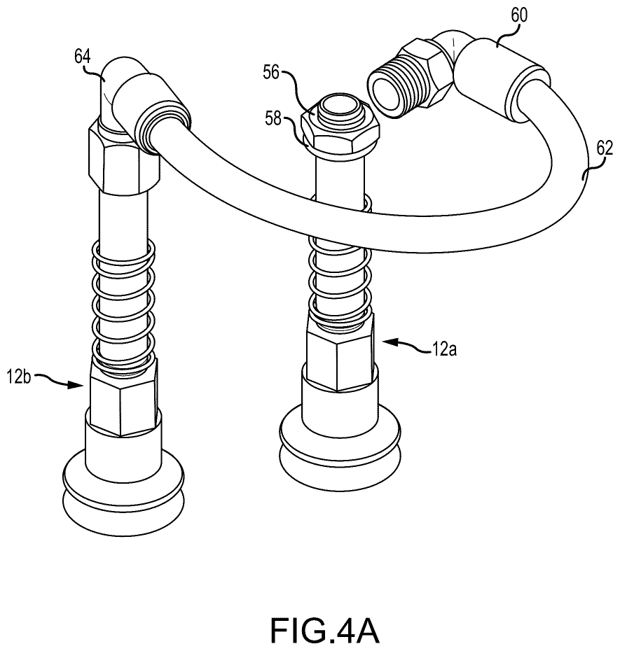

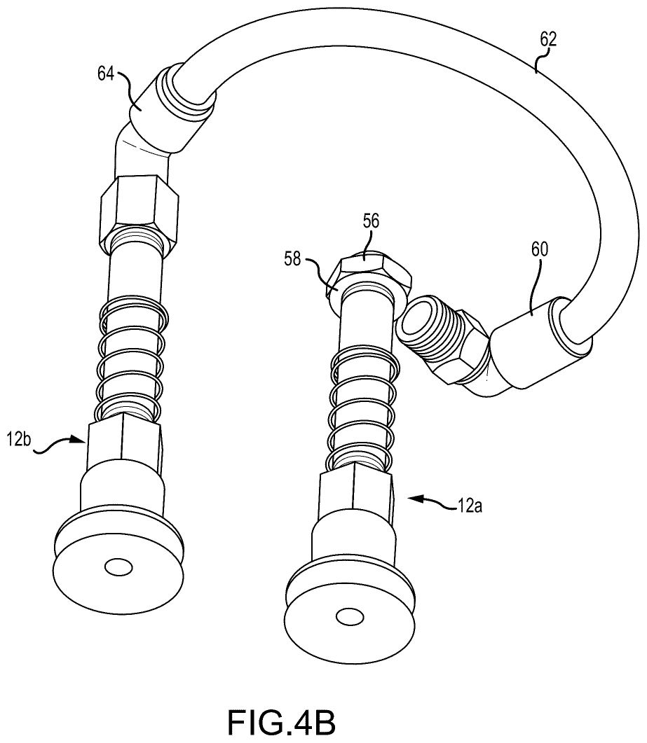

FIGS. 4A and 4B show perspective views of the spindles 12a, 12b. As described herein, the first spindle 12a is coaxial with the central conduit, and the second spindle 12b is offset from the central conduit. To assemble the first spindle 12a to the spindle flange assembly (10 in FIGS. 3A and 3B), the spindle conduit (66 in FIG. 5) of the first spindle 12a is extended through the first bushing (48 in FIGS. 3A and 3B). Then, an o-ring 58 and a nut 56 are fastened to the top of the spindle conduit (66 in FIG. 5) to seal and secure the first spindle 12a to the spindle flange assembly (10 in FIGS. 3A and 3B).

Similarly, to assemble the second spindle 12b to the spindle flange assembly (10 in FIGS. 3A and 3B), the spindle conduit (66 in FIG. 5) of the second spindle 12b is extended through the second bushing (52 in FIGS. 3A and 3B). Then, a spindle fitting 64 is joined to the top of the spindle conduit (66 in FIG. 5) to seal and secure the second spindle 12b to the spindle flange assembly (10 in FIGS. 3A and 3B). A hose 62 extends from the spindle fitting 64 to a central conduit fitting 60, which is fastened to a port of the central conduit (see port 34 in FIGS. 2A and 2B) to fluidly connect the second spindle 12b to the central conduit (4 in FIGS. 1A-2B). The hose 62 is made of a material that is more pliable and deformable than either fitting 60, 64 such that the hose 62 can flex and accommodate the movement of the second spindle 12b during operation. When the first spindle 12a moves, the first spindle 12a at least partially extends into the interior space of the central conduit (4 in FIGS. 1A-2B) and no hose is required.

FIG. 5 shows a perspective, exploded view of a spindle 12a, b, which can be either a first spindle (12a in FIGS. 1A-1C) or a second spindle (12b in FIGS. 1A-1C). The spindle 12a, b comprises a spindle conduit 66 that has an upper thread 68 and a lower thread 70. The upper thread 68 can receive a nut and seal (see nut 56 and seal 58 in FIGS. 4A and 4B) or a spindle fitting (64 in FIGS. 4A and 4B), depending on whether the spindle is the first spindle 12a or the second spindle 12b, respectively. The lower thread 70 can receive a suction cup fitting 78, to which the suction cup 16a, 16b is joined. The suction cup 16a, 16b has a lower opening 18a, 18b through which air is drawn, and the suction cup 16a, 16b is made of a material that is more pliable and deformable than the suction cup fitting 78 so that the suction cup 16a, 16b can compress and/or gimbal off axis to better conform to an irregularly-shaped object. To help provide the compression and gimbaling functions, the suction cup 16a, 16b has a corrugated portion 80 that comprises at least one ridge 82 and at least one groove 84. With the generally cylindrical shape of the suction cup 16a, 16b, the ridge 82 corresponds to a larger diameter and the groove 84 corresponds to a smaller diameter of the suction cup 16a, 16b. With at least one ridge 82 and at least one groove 84, the corrugated portion 80 can move in an accordion-like fashion.

In the depicted embodiment, the ridge 82 and the groove 84 inflect at a point, leading to the accordion-like shape. In other embodiments, the suction cup 16a, 16b have a continuous shape that does not inflect at a point. Rather, the ridge 82 and the groove 84 continuously change between an outer diameter and an inner diameter for a more rounded shape without flat portions. It will be appreciated that the present disclosure encompasses a variety of suction cup 16a, 16b shapes and a variety of ridges 82 and grooves 84.

A bias member 72 is provided to help govern the movement of the spindle 12a, b relative to the spindle flange assembly (10 in FIGS. 1A-1C). In this embodiment, the bias member 72 is a spring that is disposed around the outer surface of the spindle conduit 66 and that extends from an upper end 74 to a lower end 76. The upper end 74 braces against the respective bushing (48, 52 in FIGS. 3A and 3B), and the lower end 76 braces against the suction cup fitting 78. The bias member 72 urges the suction cup 16a, 16b away from the spindle flange assembly (10 in FIGS. 1A-1C), yet the nut (56 in FIGS. 4A and 4B) or the spindle elbow (see spindle fitting 64 in FIGS. 4A and 4B) limits how far the suction cup 16a, 16b can extend from the spindle flange assembly (10 in FIGS. 1A-1C).

When the vacuum system presses into an object, the bias member 72 compresses, and the spindle 12a, 12b moves relative to the spindle flange assembly (10 in FIGS. 1A-IC). Then, when the vacuum system disengages the object, the bias member 72 causes the spindle 12a, 12b to return to the extended position as shown in FIGS. 1A-IC. As discussed herein, the suction cup 16a, 16b can be fixed in position or floating, meaning it is able to twist, tilt, rotate and move in all degrees of freedom. Therefore, the suction cup 16a, 16b can conform to any product size or compensate for any target object distortion in shape, e.g., a crushed plastic water bottle.

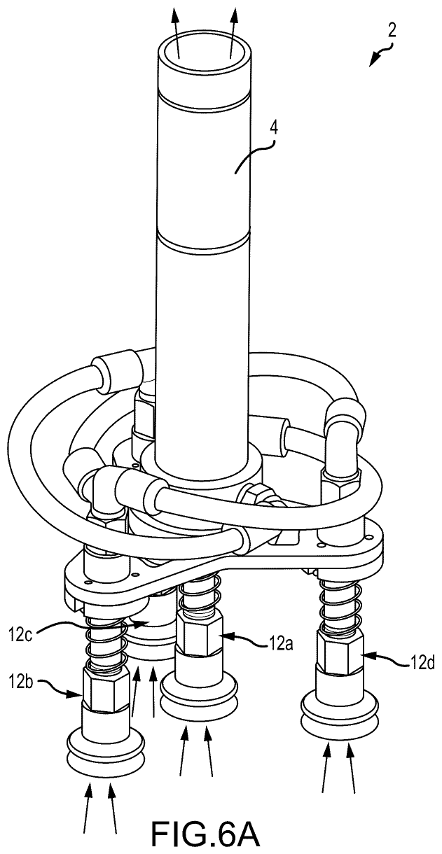

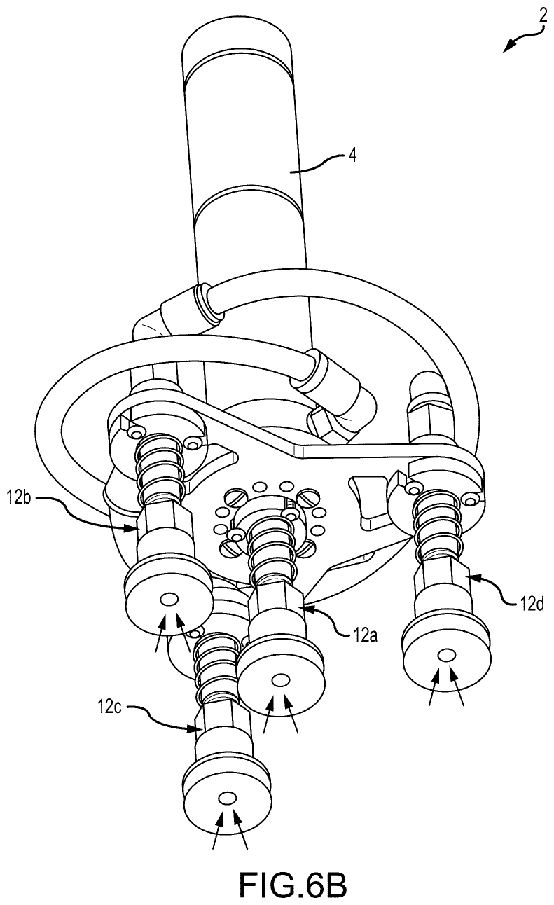

FIGS. 6A and 6B show perspective views of another embodiment of the vacuum system 2 that has four spindles 12a-12d. One spindle 12a is coaxial with the central conduit 4, and the remaining spindles 12b-12d are parallel with and offset from the central conduit 4. Embodiments with different numbers of spindles 12a-12d can be used to grasp objects with different sizes, different weights, etc.

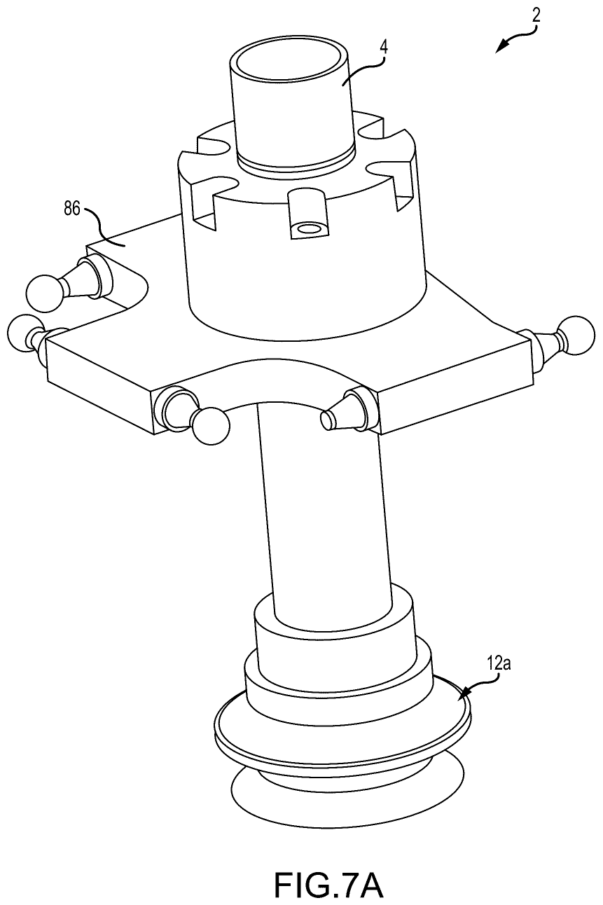

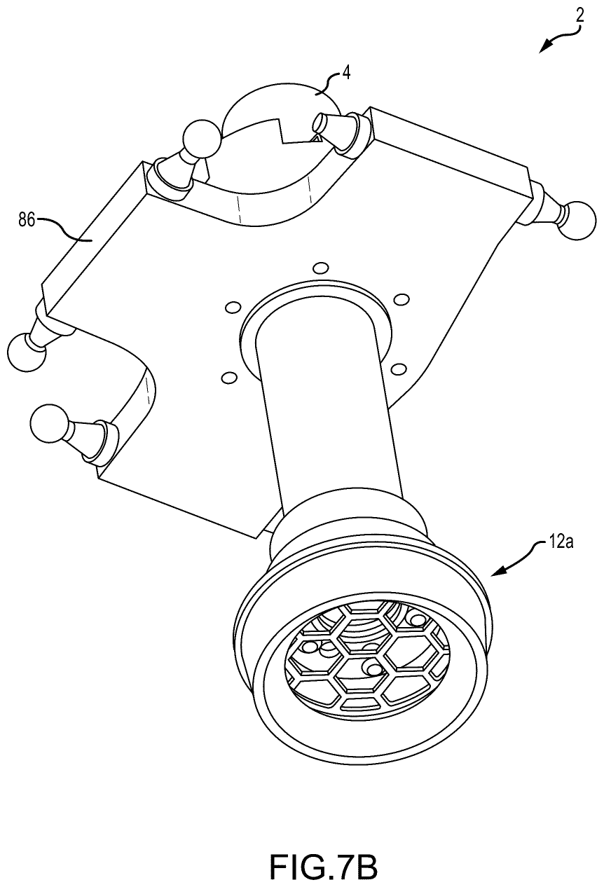

FIGS. 7A and 7B show perspective view of a further embodiment of the vacuum system 2 that has a single spindle 12a that is coaxial with the central conduit 4. Moreover, in this embodiment, a quick-connect device 86 is secured around the central conduit 4. Specifically, the device 86 can be positioned between channels (30 and 32 in FIGS. 2A and 2B), then clips or other similar components can be inserted into the channels (30 and 32 in FIGS. 2A and 2B) to hold the device 86 in place on the central conduit 4. In various embodiments, the device 86 can help hold a hose in place on the central conduit 4 to fluidly connect the vacuum system 2 to a pump or other device. In some embodiments, the device 86 allows the vacuum system 2 to be held and moved by a robotic arm.

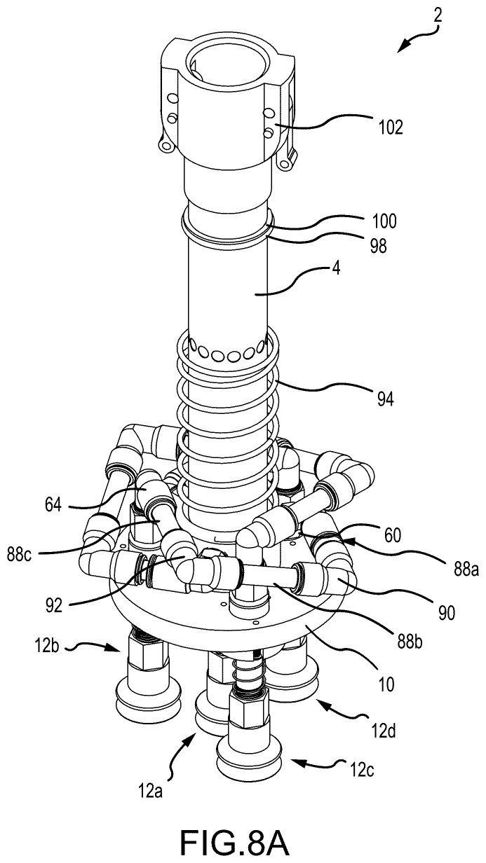

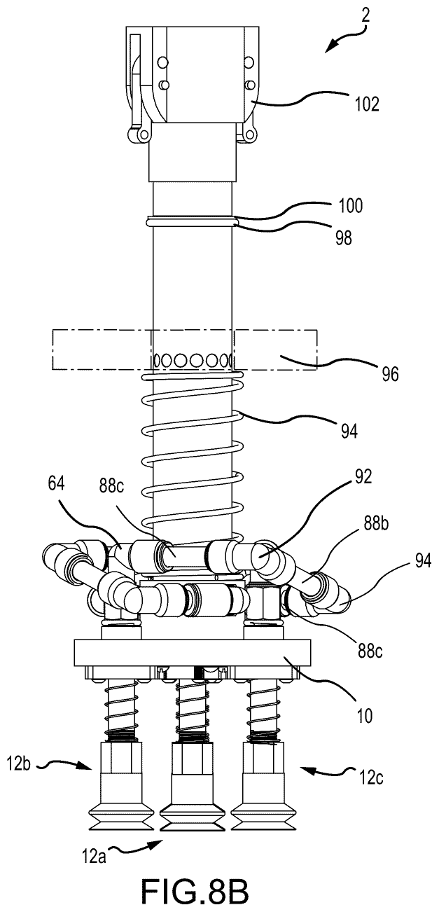

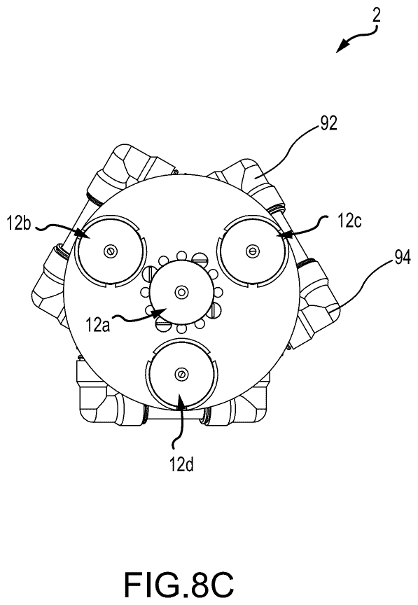

FIGS. 8A-8C show a perspective view, a side elevation view, and a bottom plan view, respectively, of another embodiment of the vacuum system 2. In this embodiment, the vacuum system 2 comprises a spindle assembly 10 with four spindles 12a-12d that can each operate as described elsewhere herein. Moreover, the spindle assembly 10 is joined to a central conduit 4, and air is drawn through each individual spindle 12a-12d, through the central conduit 4, and to a device such as a pump.

A series of rigid components, or a fluid connection assembly, joins each spindle 12a-12d to the central conduit 4. As described herein, a central conduit fitting 60 is joined to the central conduit 4, and a spindle fitting 64 is joined to an individual spindle 12b. A first elbow 90 is joined to the central conduit fitting 60 with a first tubing 88a, a second elbow 92 is joined to the first elbow 90 with a second tubing 88b, and the second elbow 92 is joined to the spindle fitting 64 with a third tubing 88c. These components 60, 64, 88a-88c, 90, 92 place the spindle 12b in fluid communication with the central conduit 4 such that air is drawn in through the spindle 12b, through these components 60, 64, 88a-88c, 90, 92, and through the central conduit 4.

It will be appreciated that these components 60, 64, 88a-88c, 90, 92 can be made from a variety of materials. Further, the various tubing 88a-88c can be made of a material that is more pliable than the materials of the other components 60, 64, 90, 92. In other embodiments, the tubing 88a-88c can be made as rigid as the other components 60, 64, 90, 92 or even the same material as the other components 60, 64, 90, 92. Pliability and rigidness can be characterized by the Young's Modulus. In some embodiments, the tubing 88a-88c can have a Young's Modulus of more than approximately 0.1 GPa. In various embodiments, the tubing 88a-88c can have a Young's Modulus of more than approximately 0.5 GPa. This configuration of rigid components or the fluid connection assembly help prevent the components 60, 64, 88a-88c, 90, 92 from hanging up on a structure or object during operation and also keep the overall dimensions of the vacuum system 2 compact.

The components 60, 64, 88a-88c, 90, 92 that fluidly connect the spindle 12b to the central conduit 4 also accommodate the motion of the spindle 12b deflecting relative to the central conduit 4. Each of the elbows 90, 92 receives moving air in one direction, and then expels moving air in a second, different direction. Moreover, the tubing 88a-88c can be configured to rotate relative to the elbows 90, 92. This rotation is shown in FIG. 8A, where the second tubing 88b is oriented along a longitudinal axis 104, and then the second tubing 88b is rotatable 106 about the longitudinal axis 104 due to the connection between the second tubing 88b and each of the elbows 90, 92. The first and third tubing 88a, 88c can be similarly disposed. Thus, these components 60, 64, 88a-88c, 90, 92 can accommodate the motion of the spindle 12b as the spindle 12b engages an object, even if all of the components 60, 64, 88a-88c, 90, 92 are rigid.

FIGS. 8A-8C also depict a bias member 94 disposed about the central conduit 4 and configured to bias the vacuum system 2. Just as bias members bias the spindles 12a-12d relative to the spindle assembly 10, the bias member 94 biases the vacuum system 2 against a plate 96 or other structure, as shown in FIG. 8B. The upper end of the bias member 94 contacts the plate 96, and the lower end of the bias member 94 contacts the spindle assembly 10 in this embodiment. As the vacuum 2 system engages an object, the force of contact causes the spindles 12a-12d to deflect and compress each of their respective bias members. Similarly, the force of contact causes the spindle assembly 10 and the broader vacuum system 2 to deflect and compress the bias member 94 against the plate 96. This deflection helps the vacuum system 2 properly engage an object. Then, as the vacuum system 2 disengages the object, the bias member 94 causes the vacuum system 2 to return to an initial position relative to the plate 96. It will be appreciated that this bias member 94 can exert a force in response to a deflection in a linear or non-linear manner. Moreover, it will be appreciated that the bias member 94 can be optional in some embodiments.

Next, a seal 98 and a clip 100 are positioned about the central conduit 4. The seal 98 can be an o-ring, and the clip 100 can quickly snap into a groove like the grooves 30, 32 described with respect to FIG. 2A. The seal 98 and the clip 100 allow for the vacuum system 2 to be quickly swapped out, for instance, for a different vacuum system 2 and configuration of spindles that is needed to grasp different objections. Then, a quick-connect device 102 at the upper end of the central conduit 4 can quickly connect to a hose and pump, which draw air through the spindles 12a-12d and the central conduit 4 to grasp an object.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the invention(s) described herein is capable of other embodiments and of being practiced or of being carried out in various ways. It is to be understood that the phraseology and terminology used herein is for the purpose of description and should not be regarded as limiting.

What is claimed is:

1. A vacuum system, comprising:
a central conduit having an interior space extending between an upper opening and a lower opening;
a spindle flange assembly joined to a lower end of the central conduit;
a first spindle movably engaged with the spindle flange assembly, wherein the first spindle comprises:
a first suction cup fluidly connected to the interior space of the central conduit, the first suction cup having an opening through which air is configured to be drawn to selectively form a seal with an object; and
a first bias member configured to bias the first suction cup away from the spindle flange assembly; and
a second spindle movably engaged with the spindle flange assembly, wherein the second spindle comprises:
a second suction cup fluidly connected to the interior space of the central conduit, the second suction cup having an opening through which air is configured to be drawn to selectively form a seal with the object; and
a second bias member configured to bias the second suction cup away from the spindle flange assembly.

2. The vacuum system of claim 1, wherein the first suction cup has a corrugated portion, and the first suction cup is oriented along an axis, wherein the first suction cup is configured to compress along the axis by up to a predetermined distance, and the first suction cup is configured to gimbal off of the axis.

3. The vacuum system of claim 2, wherein the first suction cup is joined to a first suction cup fitting of the first spindle, the first suction cup is made of a material that is more pliable than a material of the first suction cup fitting, and the corrugated portion of the first suction cup comprises a ridge and a groove, wherein a diameter of the ridge is greater than a diameter of the groove.

4. The vacuum system of claim 3, wherein the first suction cup fitting is joined to a first spindle conduit, and the first bias member is disposed about the first spindle conduit such that a lower end of the first bias member is configured to contact the first suction cup fitting, and an upper end of the first bias member is configured to contact the spindle flange assembly.

5. The vacuum system of claim 4, wherein the spindle flange assembly comprises a first bushing and a second bushing joined to a spindle flange, wherein each of the first bushing and the second bushing extend farther in a thickness direction than the spindle flange, wherein the first spindle is configured to extend through the first bushing, and the second spindle is configured to extend through the second bushing.

6. The vacuum system of claim 4, wherein the first spindle comprises a nut and a seal joined to an upper end of the first spindle conduit to secure the first spindle to the spindle flange assembly, and the first spindle is coaxial with the central conduit; and
wherein the second spindle comprises a spindle fitting joined to an upper end of a second spindle conduit to secure the second spindle to the spindle flange assembly, wherein a hose is joined to the spindle fitting, and a central conduit fitting is joined to both the hose and a port of the central conduit to fluidly connect the second suction cup to the interior space of the central conduit, and wherein the second spindle extends along an axis that is offset from an axis of the central conduit.

7. The vacuum system of claim 1, wherein the first suction cup and the second suction cup are separated by an offset, and wherein the offset is between one to two times larger than one of a first outer diameter of the first suction cup or a second outer diameter of the second suction cup.

8. A vacuum system, comprising:
a central conduit having an interior space extending between an upper opening and a lower opening;
a spindle flange assembly joined to a lower end of the central conduit;
a first spindle movably engaged with the spindle flange assembly, the first spindle having a first suction cup fluidly connected to the interior space of the central conduit, the first suction cup having an opening through which air is configured to be drawn to selectively form a seal with an object, and the first suction cup having a first outer diameter;
a second spindle movably engaged with the spindle flange assembly, the second spindle having a second suction cup fluidly connected to the interior space of the central conduit, the second suction cup having an opening through which air is configured to be drawn to selectively form a seal with the object, and the second suction cup having a second outer diameter; and
wherein the first suction cup and the second suction cup are separated by an offset, and wherein the offset is between one to two times larger than one of the first outer diameter or the second outer diameter.

9. The vacuum system of claim 8, wherein the first suction cup is configured to compress along a first axis by up to a predetermined distance, and the first suction cup is configured to gimbal off of the first axis.

10. The vacuum system of claim 8, wherein the first suction cup has a first corrugated portion with a ridge and a groove, and the second suction cup has a second corrugated portion with a ridge and a groove, wherein the offset is between the ridge of the first corrugated portion and the ridge of the second corrugated portion.

11. The vacuum system of claim 8, wherein a first suction cup fitting is joined to the first suction cup and to a first spindle conduit, and a first bias member is disposed about the first spindle conduit such that a lower end of the first bias member is configured to contact the first suction cup fitting, and an upper end of the first bias member is configured to contact the spindle flange assembly.

12. The vacuum system of claim 11, wherein the first spindle comprises a nut and a seal joined to an upper end of the first spindle conduit to secure the first spindle to the spindle flange assembly, and the first spindle is coaxial with the central conduit.

13. The vacuum system of claim 12, wherein the second spindle comprises a spindle fitting joined to an upper end of a second spindle conduit to secure the second spindle to the spindle flange assembly, wherein a hose is joined to the spindle fitting, and a central conduit fitting is joined to both the hose and a port of the central conduit to fluidly connect the second suction cup to the interior space of the central conduit.

14. The vacuum system of claim 8, further comprising a third spindle with a third suction cup having a third offset from the first suction cup, a fourth spindle with a fourth suction cup having a fourth offset from the first suction cup, and a fifth spindle with a fifth suction cup having a fifth offset from the first suction cup, wherein the third, fourth, and fifth offsets are equal to the offset between the first and second suction cups.

15. A vacuum system, comprising:
a central conduit having an interior space extending between an upper opening and a lower opening;
a spindle flange assembly joined to a lower end of the central conduit;
a first spindle movably engaged with the spindle flange assembly, wherein the first spindle comprises:
a first suction cup fluidly connected to the interior space of the central conduit, the first suction cup having an opening through which air is configured to be drawn to selectively form a seal with an object; and
a first bias member configured to bias the first suction cup away from the spindle flange assembly; and
a fluid connection assembly having a first elbow, a second elbow, and a tubing rotatably connected to each of the first elbow and the second elbow, wherein the fluid connection assembly is configured to accommodate movement of the first spindle relative to the spindle flange assembly.

16. The vacuum system of claim 15, wherein the fluid connection assembly further comprises:
a central conduit fitting joined to the central conduit;
a second tubing rotatably connected to each of the central conduit fitting and the first elbow;
a spindle fitting joined to the spindle flange assembly; and
a third tubing rotatably connected to each of the spindle fitting and the second elbow.

17. The vacuum system of claim 15, wherein the tubing is rigid and has a Young's Modulus of more than 0.1 GPa.

18. The vacuum system of claim 15, further comprising:
a second suction cup fluidly connected to the interior space of the central conduit, the second suction cup having an opening through which air is configured to be drawn to selectively form a seal with the object; and
a second bias member configured to bias the second suction cup away from the spindle flange assembly.

19. The vacuum system of claim 18, wherein the first suction cup and the second suction cup are separated by an offset, and wherein the offset is between one to two times larger than one of a first outer diameter of the first suction cup or a second outer diameter of the second suction cup.

20. The vacuum system of claim 15, wherein the first suction cup has a corrugated portion, and the first suction cup is oriented along an axis, wherein the first suction cup is configured to compress along the axis by up to a predetermined distance, and the first suction cup is configured to gimbal off of the axis.
